(19) United States
(12) Patent Application Publication
(10) Pub. No.: US 2023/0148496 A1
(43) Pub. Date: May 18, 2023

(54) DECORATIVE GARDEN WATERING APPARATUS

(71) Applicants: Barbara L. Prashaw, Martinsburg, WV (US); Etta Ziegler Combs, Martinsburg, WV (US)

(72) Inventors: Barbara L. Prashaw, Martinsburg, WV (US); Etta Ziegler Combs, Martinsburg, WV (US)

(21) Appl. No.: 18/056,230

(22) Filed: Nov. 16, 2022

Related U.S. Application Data
(60) Provisional application No. 63/279,745, filed on Nov. 16, 2021.

(51) Int. Cl. A01G 25/00

(52) U.S. Cl. CPC A01G 25/00

(57) ABSTRACT

A decorative yet useful watering device, configured to deliver water to plants for adequate irrigation below the soil is described. The device is equipped with at least one spike, configured to be placed in direct contact with the soil, and preferably partially buried. The spike is equipped with assorted holes of varying sizes which are configured to allow water to escape from a cavity disposed within an interior of the spike. A decorative element, disposed in communication with a top of a reservoir is present to disguise the device, while adding character to a garden's aesthetic. The large size of the reservoir ensures that a user need not fill the device frequently to ensure a well-watered garden or flowerbed.

### CONTINUITY

This application is a non-provisional patent application of provisional patent application No. 63/279,745, filed on Nov. 16, 2021, and priority is claimed thereto.

### FIELD OF THE PRESENT INVENTION

The present invention relates to irrigation mechanisms, and more specifically relates to a decorative garden statute and watering apparatus configured to facilitate the watering of plants in an aesthetically pleasing fashion.

### BACKGROUND OF THE PRESENT INVENTION

Remembering to water one's garden in a timely fashion requires dedication and planning on the part of the gardener. While there are many mechanisms by which one may water plants, including watering cans and irrigations systems such as sprinklers, each generally requires active participation by the gardener. This can prolong the gardener's exposure to bugs such as mosquitoes, as well as heat from the sun.

Gravity-based watering mechanisms are present on the market which are configured to be placed into the soil and provide a steady drip or flow of water, as-needed, to the soil. However, a majority of the gravity-based watering devices are small, needing to be refilled quite often, especially when used outside. Additionally, all gravity-based watering devices present on the market tend to be globe-shaped, and therefore do not help to easily uphold a certain aesthetic for a homey outdoor garden, planter, or flowerbed. If there were a larger and better gravity-based watering device which could be equipped with interchangeable decorative effects, and which housed a greater amount of water than traditional globe-shaped gravity watering devices, the aesthetic of one's garden could be matched, and the decorative effect could be changed out at will.

Thus, there is a need for a new form of gravity-based watering device configured to facilitate the semi-automated watering of one's garden from an aesthetically appealing and customizable element. Such a device is preferably configured with an easily removable decorative element placed atop and around a water reservoir which delivers water to the soil of a garden or flowerbed via a permeable spike configured to be disposed into the soil itself.

### SUMMARY OF THE PRESENT INVENTION

The present invention is an aesthetically pleasing and customizable gravity-based watering device configured to facilitate sub-terranean watering of plants conventionally found in a home garden or flowerbed in a semi-automated fashion. The apparatus is equipped with a reservoir and a permeable spike disposed in communication with the reservoir. The spike is hollow and is filled with water from the reservoir when in use. Water seeps into the soil from permeations or holes in the spike as needed. The larger size of the reservoir ensures that it needs to be refilled far less often than traditional gravity-based watering devices, and the additional space provides a location for interchangeable decorative elements. The decorative elements effectively camouflage the device, ensuring a consistent and pleasant garden aesthetic. In preferred embodiments of the present invention, the decorative element(s) is permanently connect to, or a part of, the reservoir.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the present invention as shown from the front side, isolated away from the soil, without water within the reservoir.

FIG. 2 exhibits an exploded view of the present invention from the side, showing the reservoir with integrated decorative element, support plate, and spikes full of water.

FIG. 3 shows a flow chart detailing the process of use of the present invention by a user.

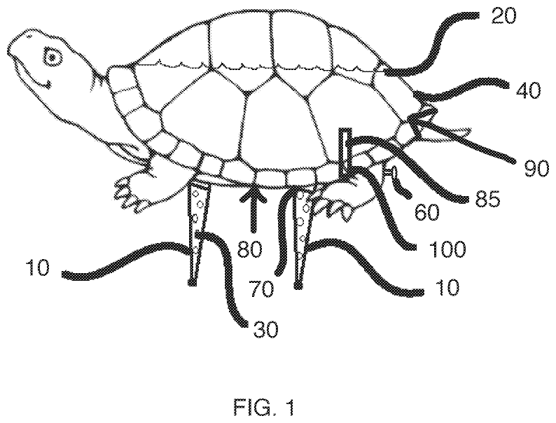

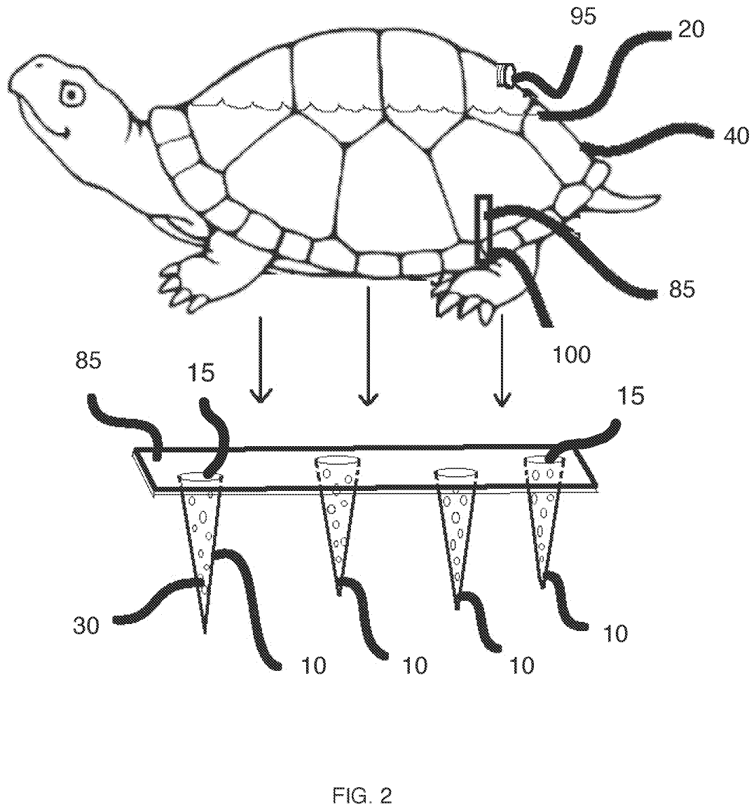

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a gravity-based watering device configured for use in a household garden, flowerbed, large flowerpot, or similar soil-based growing operation. The apparatus of the present invention is equipped with at least one spike (10), a reservoir (20) disposed in communication with the at least one spike (10), permeations, referenced as holes (30) disposed along cavities (15) within the spikes (10), and a decorative element (40). The decorative element (40) is around and atop the reservoir (20), obscuring and/or disguising the reservoir (20) when in use. In the preferred embodiment of the present invention, the decorative element (40) is molded of the reservoir (20) such that they are a unitary piece. The at least one spike (10) is configured to be disposed into the soil to facilitate saturation of the soil via the holes (30) present along the at least one spike (10). There are preferably at least 12 holes (30) present along each spike (10).

The reservoir (20) is preferably hollow and is equipped with an opening (50) to enable easy filling of the reservoir (20) with water. A valve (60) is preferably present near a junction (70) between the at least one spike (10) and the reservoir (20). The valve (60) enables the user to disable the flow of water from the reservoir (20) into the spike (10) during filling through the opening (50), as well as to enable the user to cease watering of the soil if desired (such as after a heavy rain). The valve (60) is preferably a ball-joint, two-way valve which may be opened partially for a slower flow if desired. The reservoir (20) of the present invention is preferable capable of containing between 20 and 100 gallons of water, however smaller embodiments of the present invention may be arranged so as to have a smaller reservoir (20) from 16 to 34 ounces in size.

A water-level indicator (85) is preferably present on a side (90) of the reservoir (20), which can be seen through a cutout (100) of the decorative element (40) so that it may be easily seen by the user even when the decorative element (40) is disposed atop the reservoir (20). The decorative element (40) is preferably configured to be removably affixed to the reservoir (20)

The at least one spike (10) may be removable via threading present on a bottom (80) of the reservoir (20) and threading on the at least one spike (10), allowing for easy replacement of the spike(s) if they are damaged. In some embodiments of the present invention, the at least one spike (10) is equipped with a valve. The valve may be manipulated manually, or may be equipped with a spring-action release, allowing a user to step gently on the apparatus to open or close the valve.

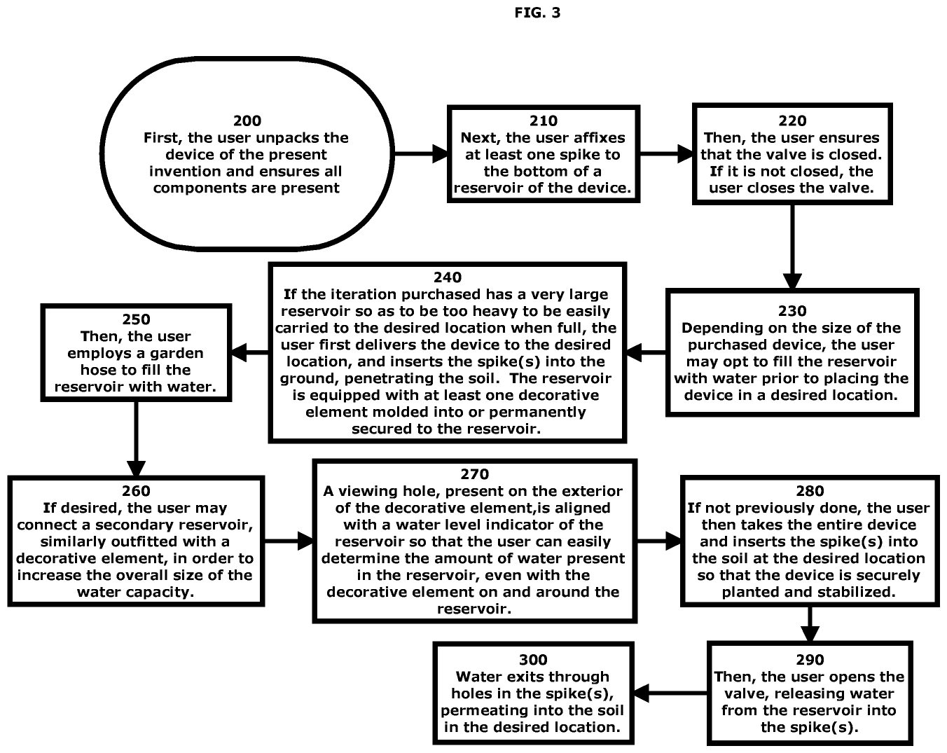

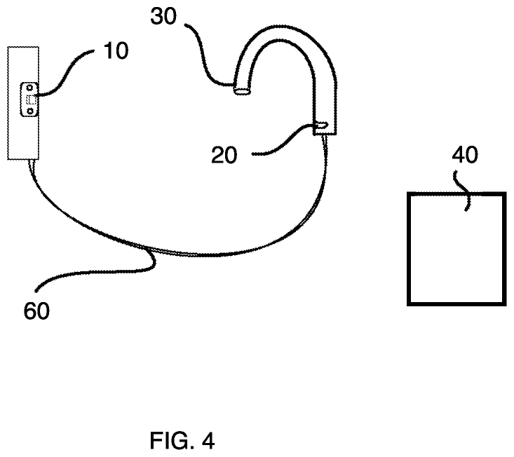

The process of use of the apparatus of the present invention, as shown in FIG. 3, is preferably as follows:
1. First, the user unpacks the device of the present invention and ensures all components are present. (200)
2. Next, the user affixes at least one spike to the bottom of a reservoir of the device. (210)
3. Then, the user ensures that the valve is closed. If it is not closed, the user closes the valve. (220)
4. Depending on the size of the purchased device, the user may opt to fill the reservoir with water prior to placing the device in a desired location. (230)
5. If the iteration purchased has a very large reservoir so as to be too heavy to be easily carried to the desired location when full, the user first delivers the device to the desired location, and inserts the spike(s) into the ground, penetrating the soil. The reservoir is equipped with at least one decorative element molded into or permanently secured to the reservoir. (240)
6. Then, the user employs a garden hose to fill the reservoir with water. (250)
7. If desired, the user may connect a secondary reservoir, similarly outfitted with a decorative element, in order to increase the overall size of the water capacity. (260)
8. A viewing hole, present on the exterior of the decorative element, is aligned with a water level indicator of the reservoir so that the user can easily determine the amount of water present in the reservoir, even with the decorative element on and around the reservoir. (270)
9. If not previously done, the user then takes the entire device and inserts the spike(s) into the soil at the desired location so that the device is securely planted and stabilized. (280)
10. Then, the user opens the valve, releasing water from the reservoir into cavities within the spike(s). (290)
11. Water exits through holes in the spike(s), permeating into the soil in the desired location. (300)

It should be noted that the size of the decorative element (40), consisting of statues and/or objects) will preferably range from very large (six feet or more) to very small (six inches in diameter or length) for use in flowerpots. Each decorative element (40) preferably lists the amount of water it will hold in gallons or ounces within the reservoir (20) included therein. Each statue/object has a water level indicator (80) at the bottom, to indicate when a refill is required.

Further, some of the larger statues/objects are constructed such that additional items can be attached to the decorative element (40). For example: A turtle or fairy could be added to a rock formation decorative element (40). The top would be removed from the decorative element (40), and the turtle or fairy would be attached at the opening and the new opening will be on the Turtle, Fairy or whatever similar addition has been added to the original statue/object. In such embodiments, the additional item would include an additional reservoir, thereby increasing the overall volume of water capacity.

Additionally, some of the decorative elements (40) are preferably equipped with LED Lighting which is battery powered. The batteries are preferably rechargeable batteries and may be disposed in communication with one or more solar panels to facilitate recharging of the batteries via sunlight. Battery-powered decorative elements (40) may provide movement to objects such as Fairy Wings or facilitate the playback of sounds from one or more speakers, such as frogs croaking. For example: an alligator added to a log-shaped decorative element (40) could be configured to open its mouth, eyes flash and bellows. Some of our statutes/objects are preferably poseable, i.e. a dragon.
a) All of the decorative elements (40) are preferably brightly colored representing the objects in their natural or imaginary depictions.
b) Decorative elements (40) (with integrated reservoir (20)) and Spikes (10):
   1) Are replaceable if lost or broken.
   2) Are interchangeable. i.e. a Fairy in the Summer, Scarecrow in the Fall, Santa in Winter, all using the same spike (10).
   3) If storing for the Winter, decorative elements (40) are removeable from the spikes (10) to be stored.
   4) To protect the spike(s) (10) while the statue/object is in storage, a cap is preferably included to prevent dirt and debris falling into the spike/poles.
   5) The spike(s) (10) are drilled with holes to evenly distribute the water as the ground dries.
c) The decorative element (40) of the present invention will be made of various materials. The present invention is hollow inside (to form the reservoir (20), making it easier to move and/or change with other items.
d) The decorative element (40), depending on the size, is preferably fashioned and reinforced to withstand a small child's average weight.

Further, it should be noted that in some alternate embodiments of the present invention, a bottom of the reservoir (20) is preferably equipped with a male garden hose attachment (95), configured to facilitate the connection of a garden hose to facilitate and expedite filling of the reservoir (20). This is especially helpful for iterations of the present invention which are quite large, such as those configured to contain 100 gallons of water. Likewise, a garden hose attachment enables the user to directly use the apparatus of the present invention to water the soil of a garden or flowerbed directly as well. An additional female garden hose adapter may be present opposite the male garden hose adapter to enable the user to attach a sprinkler, soaker, or similar irrigation mechanism.

In preferred embodiments of the present invention, a plate (85) is preferably present beneath the reservoir (20), above the spikes (10) which helps to prevent the spikes from seeping too deeply into the soil. The plate (85) prevents the unintentional slow burial of the apparatus from erosion and rain.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A gravity-based watering device comprising:
a reservoir;
at least one spike;
holes extending to a cavity disposed within said at least one spike;
wherein said cavity is connected to said reservoir; and
a decorative element, said decorative element disposed atop and around said reservoir.

2. The apparatus of claim 1, further comprising:
a valve, said valve disposed between said cavity of said at least one spike and said reservoir;
a water-level indicator, said water-level indicator disposed on a side of said reservoir; and
wherein said valve is configured to manipulate the flow of water from said reservoir to said cavity of said at least one spike.

3. The apparatus of claim 1, wherein at least 12 holes are present along said at least one spike.

4. The apparatus of claim 1, wherein said decorative element is removable.

5. The apparatus of claim 1, wherein said at least one spike is removable via a threaded connector.

6. The apparatus of claim 1, further comprising:
a male garden hose adapter, said male garden hose adapter disposed on a side of said reservoir; and
wherein said male garden hose adapter facilitates the filling and refilling of said reservoir with water.
